(19) United States
(12) Patent Application Publication
(10) Pub. No.: US 2008/0235146 A1
(43) Pub. Date: Sep. 25, 2008

(54) System and method for affirming over the counter derivative trades

(75) Inventors: Sunil G. Hirani, New York, NY (US); Mazyar M. Dar, New York, NY (US); Benjamin Lis, New York, NY (US); Mark I. Beeston, London (GB); Christopher J. Crowley, New York, NY (US); Marc Teichman, Brooklyn, NY (US); Joe Berardo, Huntington, NY (US); Clive P. De Ruig, New York, NY (US)

Correspondence Address: MORRISON & FOERSTER LLP, 1650 TYSONS BOULEVARD, SUITE 400, MCLEAN, VA, 22102, US

(73) Assignee: Creditex Group, Inc., New York, NY (US)

(21) Appl. No.: 11/882,090

(22) Filed: Jul. 30, 2007

Related U.S. Application Data
(60) Provisional application No. 60/833,793, filed on Jul. 28, 2006.
(60) Provisional application No. 60/836,693, filed on Aug. 10, 2006.
(60) Provisional application No. 60/906,530, filed on Mar. 13, 2007.

(51) Int. Cl. G06Q 40/00

(52) U.S. Cl. 705/80

(57) ABSTRACT

Methods and systems that provide a post-trade affirmation and messaging service. This service allows parties to affirm trades with their counterparties prior to processing. The addition of this affirmation layer helps ensure that all the key economic details of the trade including allocations, reference entity, payment dates etc. are agreed to between both counterparties immediately after execution. va-21 1431

### REFERENCE TO RELATED APPLICATIONS

This application claims priority to U.S. Provisional Application No. 60/833,793 filed Jul. 28, 2007, U.S. Provisional Application No. 60/836,693, filed Aug. 10, 2006, and U.S. Provisional Application No. 60/906,530, filed Mar. 13, 2007, the contents of which are hereby incorporated by reference.

### FIELD OF INVENTION

This invention relates generally to methods and platforms that provide post-trade affirmation and messaging services. This service allows parties to affirm trades with their counterparties prior to processing.

### BACKGROUND OF INVENTION

Currently, conventional credit derivative markets include a user base of larger institutions. These larger institutions use the credit derivative markets for a variety of reasons. For example, commercial banks, both domestic and foreign, can obtain significant economic, regulatory, and capital relief from selling credit risk in a credit derivative market. Commercial banks can also use the credit derivative markets to add credit risk to their portfolios as an alternative to the lending market. Insurers, who typically posses excellent credit evaluation skills, primarily use the credit derivative markets to take on credit risk for a premium. Investment management companies and Hedge Funds, or other investors, use the credit derivative markets to both take on and shed risk.

The dealer community represents some of the largest financial intermediaries in the world. The dealers tend to be large, multi-national institutions that make markets in credit derivatives. The scale and scope of each dealer's credit derivative business varies widely, with some dealers having extensive credit derivative operations, and other being occasional market participants.

### SUMMARY OF THE INVENTION

Currently the trading of credit derivative contracts occurs by direct contact between a dealer and a buyer. FIG. 1 is a flow diagram of the current new trade process. As shown in FIG. 1 the dealer and the buyer then each submit the trade details to a matching platform such as Depository Trust & Clearing Corporation (DTCC) DERIV/Serv for execution. If the trade details do not match exactly the DTCC server does not execute the trade and the trade fails. The parties then have to reenter the details, assuming that it was an entry error, or renegotiate the trade details if the error was an understanding between the parties. FIG. 2 is a flow diagram of the current novation process. The errors in this process are even more common than in a new trade process since the trade details of three separate parties need to agree for a trade to be executed. Fixing these errors after the time of the trade can be difficult and inefficient. Accordingly, a need exists for a new way to affirm trades.

One embodiment of a method according to invention includes receiving from a first party trade details concerning a credit derivative trade, transmitting the trade details to a second party, receiving from the second party an affirmation or a rejection, and notifying the first party of the affirmation or the rejection.

A rejection may be received from the second party along with a reason for the rejection. The method may include receiving modified trade details from the first party following the rejection. The method may also include transmitting the modified trade details to the second party and receiving from the second party an affirmation of the modified trade details.

The method may further include transmitting the trade details to a matching trade settlement system.

A method of novating a credit derivative trade may include receiving from a transferor details concerning an original credit derivative transaction between the transferor and a remaining party, transmitting the trade details to the remaining party and a transferee, receiving from the remaining party an affirmation or a rejection, receiving from the transferee an affirmation or a rejection, and notifying the transferor of the affirmation or rejection received from the remaining party and the transferee.

The method may further include affirming the novation if an affirmation is received from both the remaining party and the transferee. The trade details of an affirmed novation may be transmitted to a matching trade settlement system. The method may also include rejecting the novation if a rejection is received from either the remaining party or the transferee.

The method may also include receiving a rejection from the remaining party or the transferee and receiving a reason for the rejection along with the rejection. The method may further include receiving modified trade details from the transferor following a rejection, transmitting the modified trade details to the remaining party and the transferee, receiving an affirmation of the modified trade details from the remaining party and the transferee, and transmitting the modified trade details to a matching trade settlement system.

A method of auto-affirming trade details may include receiving from a first party first trade details concerning a credit derivative trade, receiving from a second party second trade details concerning a credit derivative trade, transmitting the first trade details to the second party, and auto-affirming the first trade details when the first trade details match the second trade details.

A method for exercising credit derivative options may include receiving details concerning a plurality of credit derivative options, receiving weekly fixings concerning the plurality of credit derivative options, displaying the weekly fixings to a first party, and receiving from the first party an indication of whether to exercise one or more of the plurality of credit derivative options. The method may further include transmitting to a second party the indication of whether to exercise one or more of the plurality of credit derivative options.

A trade system may include a first party system including a first party interface configured to receive from a first party trade details concerning a credit derivative trade, and a second party system in communication with the first party system and include a second party interface configured to receive from a second party an affirmation or a rejection concerning the trade details.

Another embodiment of a trade system may include a first party system including a first party interface configured to receive from a first party trade details concerning a credit derivative trade, a second party system in communication with the first party system and including a second party interface configured to receive from a second party an affirmation or a rejection concerning the trade details, and a third party system in communication with the first party system and comprising a third party interface configured to receive from a third party an affirmation or a rejection concerning the trade details.

### BRIEF DESCRIPTION OF THE DRAWINGS

FIG. 1 is a flow diagram of the current new trade process.

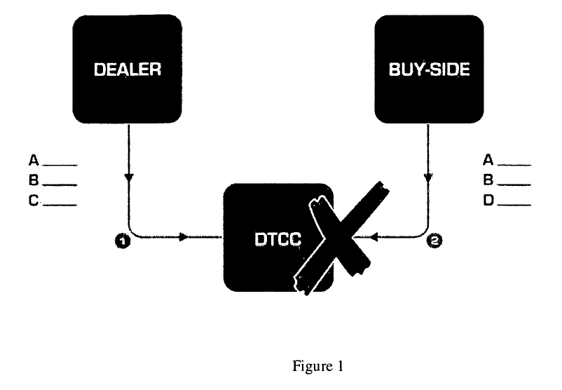

FIG. 2 is a flow diagram of the current novation process.

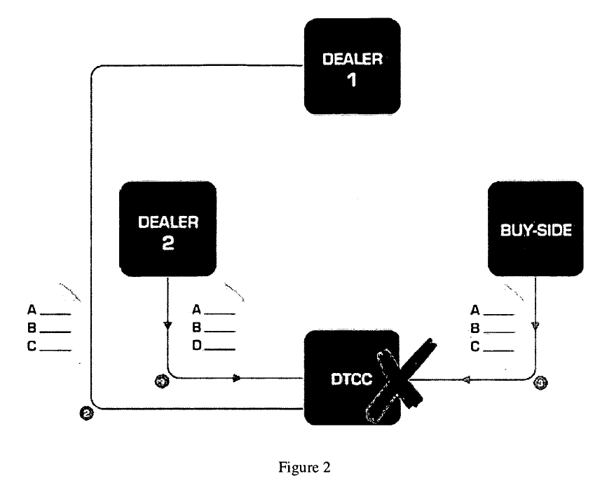

FIG. 3 is a flow diagram that summarizes a new trade procedure in which a trade is executed at DTCC.

FIG. 4 shows a screen that can be used by a dealer to enter new trade details into the platform for a single name trade.

FIG. 5 shows a screen that can be used by a dealer to enter new trade details into the platform for a new index trade.

FIG. 6 shows a screen that can be used by a dealer to enter new trade details into the platform for a new index tranche trade.

FIG. 7 shows an example of an investment advisors main blotter screen.

FIG. 8 shows an allocation screen that can be used to allocate a trade across multiple funds.

FIG. 9 show an example of an investment advisor screen for entering details for terminating a single name CDS trade.

FIG. 10 shows an example of the main dealer screen after a termination has been received from an investment advisor.

FIG. 11 is an example of an investment advisor's position blotter screen.

FIG. 12 is an example of an investment advisor's screen for entering details for novating a single name CDS contract transaction.

FIG. 13 shows an example of a dealer screen after receipt of an alleged novation.

FIG. 14 is an example of a prime broker give-up acceptance screen.

FIG. 15 shows a view of the investment advisor screen after a trade has been rejected.

FIG. 16 shows an example of an investment advisor screen during a trade void.

FIG. 17 shows an example of a dealer screen in which an un-affirmed transaction is being recalled so that the transaction can be modified and re-alleged.

FIG. 18 shows an example of the capture new trade on an investment advisor screen.

FIG. 19 shows an example of an investment advisor screen of an auto-affirmed new trade.

FIG. 20 shows investment advisor screens used for reconciling a trade that was not auto affirmed.

FIG. 21 is a flowchart summarizing the auto-affirmation features.

FIG. 22 is a flow diagram of the process for exercising CDS options on the platform.

FIG. 23 is a view of the option screen for an option buyer.

### DETAILED DESCRIPTION OF THE INVENTION

Definitions

Following is a list of terms used herein and their meanings:

Affirmation: The positive acknowledgement of a derivatives transaction by a party on the Platform.

Allege: The initial messaging of trade details through the platform by the party who initiates the workflow.

Allocation: The distribution or splitting of a trade between two or more funds managed by an Investment Advisor.

Authorizer: An individual designated by a participant to provide platform authorizations.

Counterparty Authorization: The approval given by a dealer to transact with a particular investment advisor fund on the platform.

Credit Derivatives Physical Settlement Matrix: A spreadsheet published by ISDA that specifies all legal terms for a particular credit derivatives contract.

Dealer: A credit derivatives dealer or market-maker.

Fund: A hedge fund or other institutional account managed by, for example, an investment advisor that can act as counterparty to a derivatives transaction.

Give Up Trade: A derivatives transaction entered between an Investment Advisor and a dealer that is given up to a prime broker.

Investment Advisor: A legal entity, including asset managers and investment managers, that is authorized to act as agent for, or otherwise trade on behalf of, a fund.

New Notional: The notional amount after a termination or novation has occurred.

New Trade: A new derivatives transaction entered into between two parties. This can occur outside of the platform.

Notional Amount: The calculation amount in a credit derivatives contract.

Novation: The transfer by cancellation of an existing contract between the remaining party and the transferor and execution of a new contract between the remaining party and the transferee.

Over-the-counter (OTC) derivatives: are derivative contracts that are traded (and privately negotiated) directly between two parties.

Platform: The connectivity and electronic messaging system that is used for the post-transaction processing of trade details, the functionality of which is further described herein. References to “Platform” may include related software and documentation. The platform may include the user interfaces and the server system, which implements the functionality of the platform and which delivers and accepts data to the use systems.

Prime Broker: A credit derivatives dealer or market-maker intermediating transactions between dealers and investment advisors.

Product: A financial instrument that can be processed via the platform.

Rejection: The rejection of a derivatives transaction by a party on the platform.

Recall: The recall of a derivatives transaction by a party on the platform prior to affirmation of a trade.

Software: The computer applications that allow users to interface with the platform. The software may include a Graphical User Interface (GUI).

Termination: Early settlement of a derivatives contract. Also known as an “unwind” or “tear-up.”

Trade: A derivatives contract between two counterparties. This may occur outside of the platform.

Trade Details: Information relevant to a trade, including economic details, date and counterparty information.

Trade Status: A status associated with each trade in the Trade blotter portion of the platform.

Transaction Type: The jurisdiction specified in the credit derivatives physical settlement matrix, which specifies all legal terms for a particular credit derivatives contract.

Void: An affirmed transaction on the platform that has been agreed as invalid between the parties.

The disclosed methods and platform allow counterparties to a transaction to dramatically reduce operational risks and costs associated with the trading of financial instruments, such as credit derivatives, particularly over-the-counter credit derivatives. Although the following description of the methods and platform is specific to the trading of over-the-counter credit derivatives, similar methods and platforms can be utilized to improve the trading of a variety of financial instruments.

The platform helps ensure that all key economic details of a transaction are agreed upon by the counterparties to a trade. Preferably, this is accomplished immediately after the execution of the transaction between the counterparties—i.e., on the date of the trade. The platform reduces operational risks by ensuring accurate trade capture and by providing connectivity to support downstream processing of transactions outside of the platform.

The platform uses an affirmation model to obtain electronic verification of trade details from parties to a trade. Trade details are delivered in real-time to each party's trade capture system via system-to-system links. In addition, trade details can be delivered to third parties, including prime brokers, fund administrators, and confirmations matching platforms such as DTCC DERIV/Serv. The Platform may incorporate established market standards including RED, ISDA and FpML.

The platform may support single-name CDS, CDS indices (such as for example, iTraxx, CDX ABX, TABX, LCDX, LevX, and CMBX) and index tranches. The platform may support processing of new trades, terminations, novations and amendments. In addition, the platform may automate the allocation of trades across multiple funds.

The platform may include a trade exporter tool that allows for customizable trade activity downloads, in real-time, to a file stored on a users desktop or network. The trade exporter may permit clients to designate which trade details are needed and at which time intervals the information is needed. The trade exporter may provided users the ability to apply trade details to trade capture, risk, accounting, or fund administrator systems thereby reducing dual entry risk and operational efforts. The trade exporter software may provide pre-configured trade data extract requests that return data in, for example, a comma separated value (CSV) file format. The software may also allow for source code customization for more sophisticated extract requests.

The platform is a connectivity and messaging platform that can be used for the post-trade processing of trade details. The platform may or may not include trading and legal execution/clearance functions.

Platform—Basic Operation

The Platform may provide post-transactional affirmation services to market participants in the over-the-counter derivatives market. Market participants include derivative dealers, users (for example, hedge funds, asset managers, etc.), intermediaries (for example, brokers, prime brokers, etc.) and service providers (vendors, administrators, custodians, clearing houses, etc.).

The platform can be utilized by users who have entered into credit derivative transactions outside of the platform. After entering into a trade with a transaction counterparty, a client enters the key details of the trade that he wants to allege against such counterparty into the platform. The transaction counterparty then either affirms the alleged transactions as valid or rejects the alleged transactions as invalid, adding any additional data that may be required. The data is then messaged back to the originating institution, either through an electronic API, a graphical user interface (GUI), or an e-mail message. The platform can also be integrated with a client's internal transaction capture platform; this may eliminate the need for the initial manual input of the trade details by the initiating party by routing trades automatically across the platform and onto the relevant counterparty's trade capture platform.

The graphical GUI interface of the platform can run on one or more computer systems including, for example, a PC with a Pentium/1.0 GHz or higher microprocessor, running Microsoft WINDOWS, and having a connection to a network, such as the Internet. The platform can also include one or more servers configured to accept the relevant transactional information from the one or more counterparties and reroute the relevant information to the one or more counterparties. A network connection, for example an internet connection, can be used to provide a connection between the one or more servers and the different counterparties.

Once a transaction is affirmed, each counterparty to the trade has an accurate electronic record of the key details of the transaction and can deliver these details to downstream systems outside of the platform. The platform may include connectivity to these outside systems. For example, clients can send transaction details to electronic confirmation vendors in order to legally execute the transaction. In addition to this functionality, the platform can also transmit client transaction data onto other third party platforms such as platforms of client designated market intermediaries (inter dealer brokers, dealers to client brokers or prime brokers) and/ or operational vendors (fund administrators, risk management, valuation or other settlement services providers).

The platform may be designed not to execute or clear any transactions, engage in market-making activities, take proprietary positions in such transactions or otherwise hold securities, hold or receive client funds or securities and does not carry any customer accounts. In addition, the platform may not provide investment advisory services to users or display live or indicative prices for the purpose of price discovery or trade execution.

Clients that utilize the platform may include dealers, investment advisors, prime brokers, fund administrators, and other third parties such as custodians and vendors.

Transactions that can be made on the platform may include new trades, allocations, terminations (including partials), novations (including partials), and amendments. The platform can also indicate in real time the current status of the transactions to users. Status indicators include alleged, amended, affirmed, terminated, novated, rejected, recalled, and voided.

CDS, CDS indices, and index tranches trades may be supported by the platform. Details that may be entered for a single name CDS trade may include buyer (of protection), trade date, seller (of protection), effective date, reference entity, maturity date, reference obligation, first pay date, RED Pair Clip, payment frequency, ISIN, CUSIP, Bloomberg, ID, upfront fee, notional, upfront fee date, fixed rate, transaction type, restructuring, confirmation method, initial margin, agreement date, margin payer, calc agent, and calc city.

Details that may be entered for a CDS index trade may include: buyer (of protection), effective date, seller (of protection), maturity date, index, first pay date, RED ID, payment frequency, notional, upfront fee, spread, upfront fee date, deal spread, transaction type, initial margin, confirmation method, margin payer, agreement date, trade date, calc agent, and calc city.

Details that may be entered for a CDS index tranche trade may include: buyer (of protection), trade date, seller (of protection), effective date, index, maturity date, RED ID, first pay date, notional, payment frequency, tranche spread, upfront fee, deal spread, upfront fee date, attachment %, transaction type, detachment %, confirmation method, initial margin, agreement date, margin payer, calc agent, and calc city.

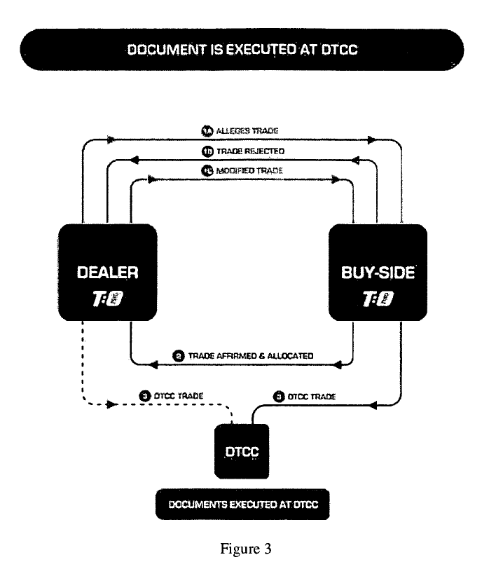

FIG. 3 is a flow diagram that summarizes a new trade procedure in which a trade is executed at DTCC. In FIG. 3 a dealer alleges a new trade against a buyer at 1A. At 1B, the buyer rejects the trade because the trade details contain one or more errors. The buyer's rejection includes a message detailing the errors. At 1C, the dealer corrects the errors in accordance with the buyer's message. At 2 the buyer affirms the modified trade. At 3 the dealer and the buyer both submit the exact same trade details to DTCC for execution. Instead of submitting the trade details to DTCC the dealer and buyer may execute the trade using paper documents or other systems.

The above fields are only exemplary additional or alternative fields for each trade may be covered by the platform. For example, for credit derivative trades, if DTCC adds any obligatory matchable fields to a Product that is supported by the platform, the field in the platform will be extended to cover such additional obligatory matchable fields.

Affirmation of New Transactions and Terminations

Platform users can use the platform to enter the details of a new transaction or a transaction that they have agreed to terminate/unwind on the platform. To do so, a user completes a transaction record setting out the details of the new trade or the termination details. The record is then sent to the transaction counterparty, which can either affirm or reject the relevant transaction details. When rejected, the rejecting party enters a comment explaining the reason for the reject and the record is then amended and resubmitted by the other party. Transaction records can also be recalled before being submitted to the other participant or voided if they need to be amended after they have already been affirmed by both parties (all parties have to insert a comment to explain the reason for the record being voided). After a transaction is recalled, rejected or voided, the initiating user can amend the details of the transaction and resubmit the record to the relevant counterparty.

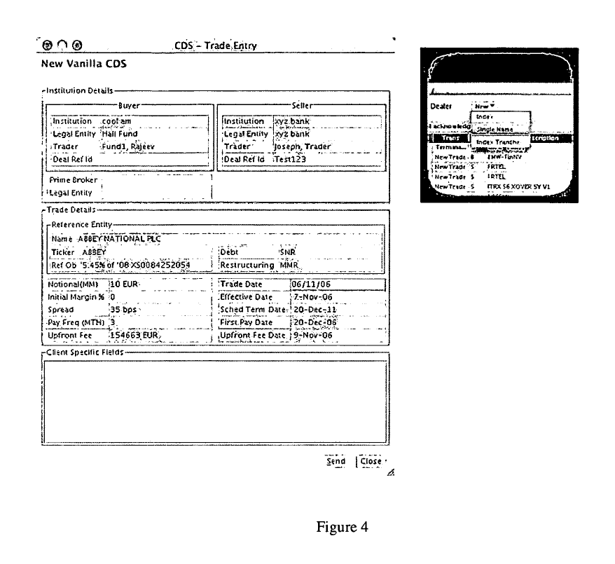

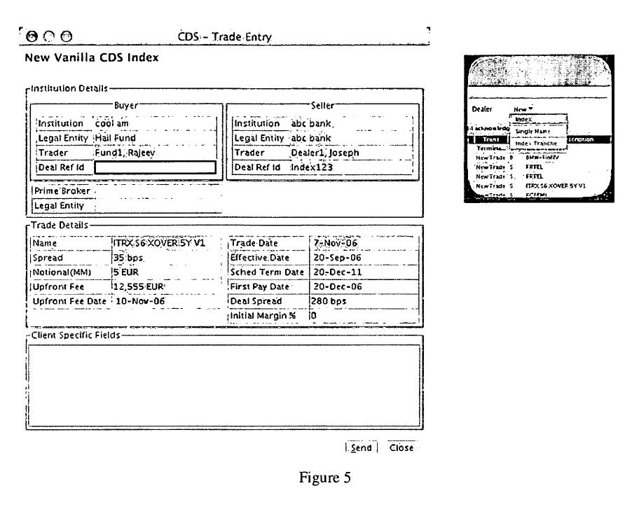

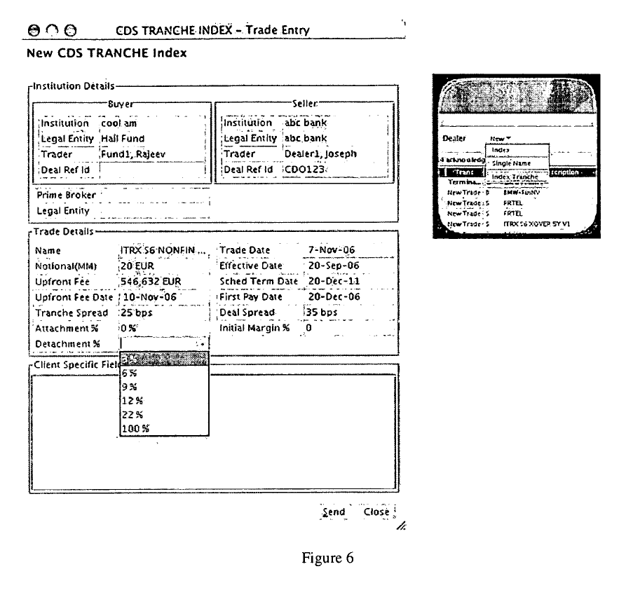

For example, in a new credit derivatives trade, a dealer may first enter all relevant trade details into the platform and allege them to an investment advisor. The investment advisor can either affirm or reject the trade. FIG. 4 shows a screen that can be used by a dealer to enter new trade details into the platform for a single name trade. Also shown in FIG. 4 is how this screen can be accessed from a new trade drop down menu on the main dealer screen. FIG. 5 shows a screen that can be used by a dealer to enter new trade details into the platform for a new index trade. Also shown in FIG. 5 is how this screen can be accessed from a new trade drop down menu on the main dealer screen. FIG. 6 shows a screen that can be used by a dealer to enter new trade details into the platform for a new index tranche trade. Also shown in FIG. 6 is how this screen can be accessed from a new trade drop down menu on the main dealer screen. An alleged trade may be indicated on the dealer and investment advisor screen; for example, by placing a question mark next to the trade.

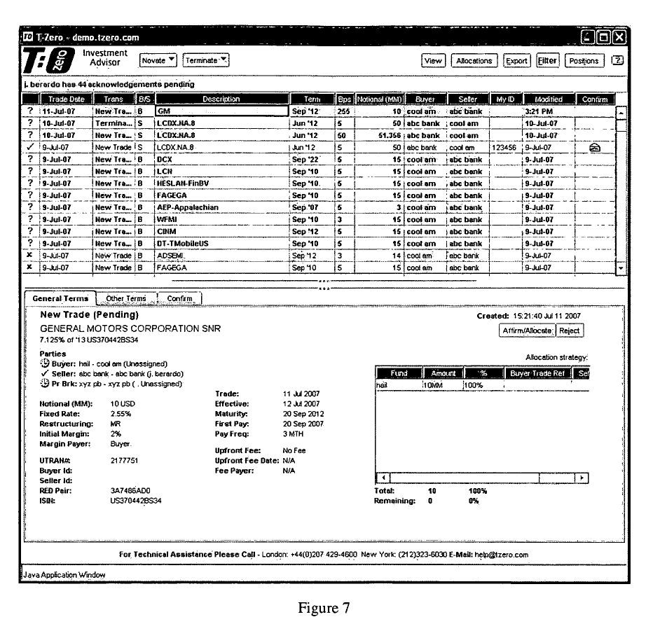

FIG. 7 shows an example of an investment advisors main blotter screen. From this main blotter screen an investment advisor can chose to allocate new trades, launch reports, view positions, initiate novation or termination transactions, create/modify allocation strategies, submit trades to DTCC for legal confirmation, view a DTCC legal confirmation status.

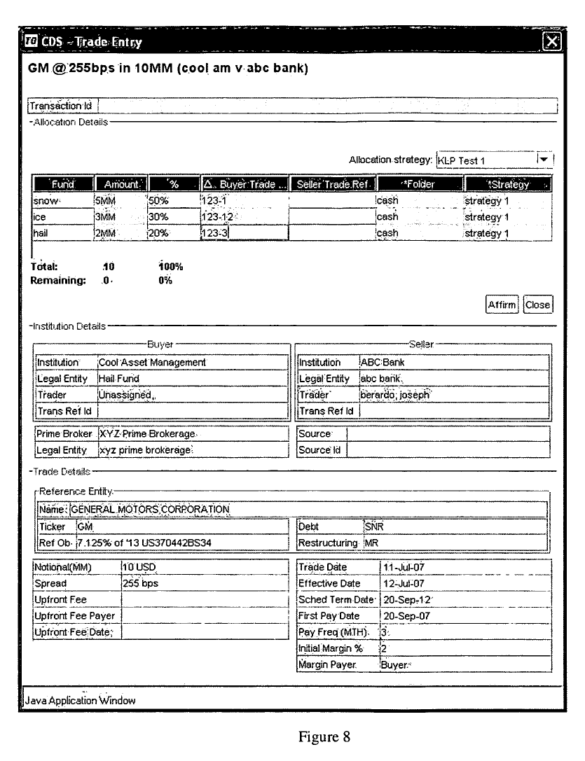

If the investment advisor desires to allocate a trade across multiple funds, it may be required to do so prior to affirmation of the trade details. FIG. 8 shows an allocation screen that can be used to allocate a trade across multiple funds. This screen can be accessed from the main blotter screen.

From the main dealer screen, the dealer may also have the ability to recall a trade prior to affirmation of such trade. The platform may allow the dealer to modify and resubmit recalled trades.

If the investment advisor affirms the trade details, the platform may generate a single trade ticket for the trade if the trade was not allocated or a separate trade ticket for each allocation where the trade was allocated across multiple funds. Affirmed trades may be indicated on the dealer and investment advisor screens; for example, by placing a green checkmark next to the affirmed trade.

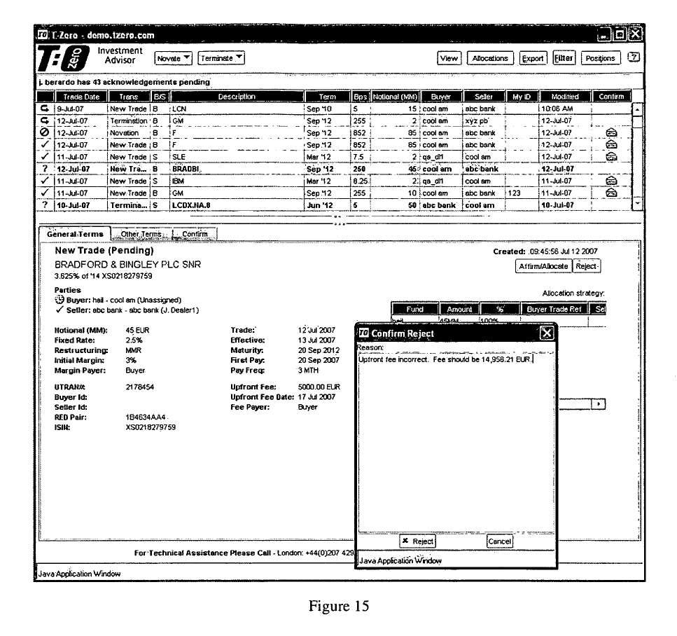

If the investment advisor rejects the trade details, the platform can send a reject message back to the dealer. FIG. 15 shows a view of the investment advisor screen after a trade has been rejected. The screen in FIG. 15 includes a window for input a reason for the rejection. The investment advisor may be required to add a comment explaining why the trade was rejected. Such rejected trades may be indicated on the dealer and investment advisor screens; for example, by placing a red “X” next to the rejected trade. The platform may allow the dealer to modify and resubmit the rejected trade.

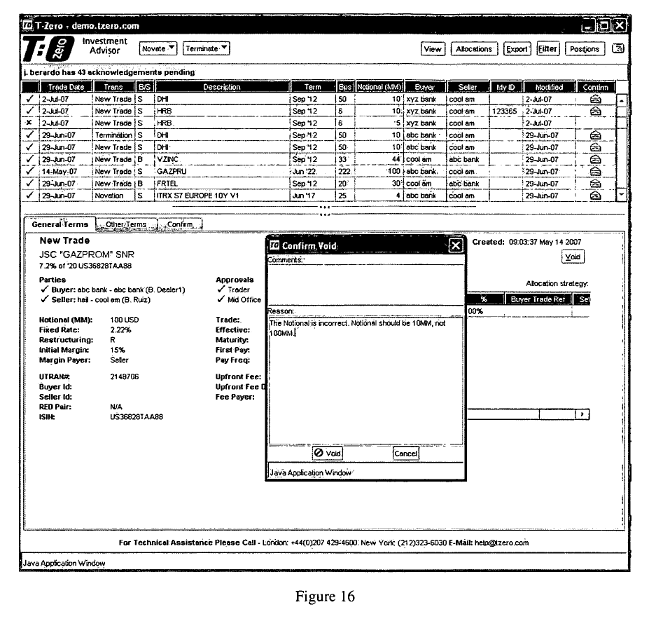

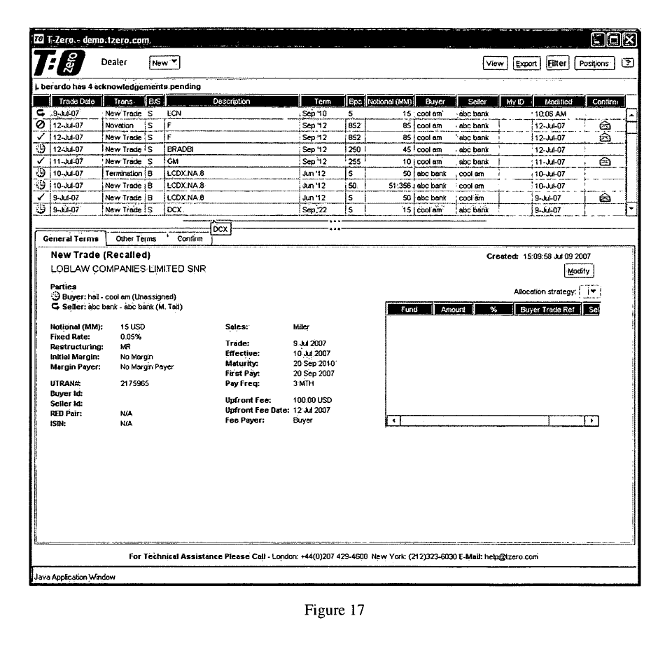

Either party to a trade may have the ability to void a trade whose trade details have been affirmed. Prior to allowing a trade to be voided, both parties may be required to agree that the trade should be voided and to add a comment explaining why the trade was voided. FIG. 16 shows an example of an investment advisor screen during a trade void. The screen in FIG. 16 includes a window for inputting the reason for the void. The platform may allow the dealer to modify and resubmit voided trades. FIG. 17 shows an example of a dealer screen in which an un-affirmed transaction is being recalled so that the transaction can be modified and re-alleged.

If the trade is in either an alleged or affirmed state, the platform may allow the dealer to allege an amendment to modify the trade details. All parties to the trade must affirm the amendment.

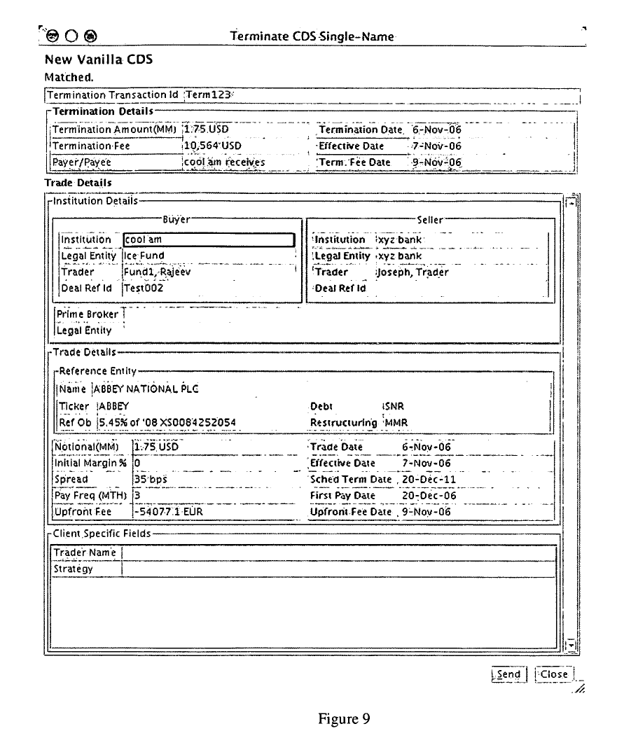

Terminations can be initiated by an investment advisor, who alleges the termination details to the dealer. FIG. 9 show an example of an investment advisor screen for entering details for terminating a single name CDS trade. If the original trade was affirmed via the platform, the investment advisor may select the option to terminate the trade and enter the relevant termination details (as defined below). The investment advisor may have the option to terminate (a) a single allocation, (b) an entire block trade or (c) multiple allocations within a block trade. If the original trade was not affirmed via the platform, the investment advisor may enter the original trade details, as well as the termination details, into the platform.

Termination details may include termination amount, termination spread, termination fee, payer/payee, termination date, effective date, termination fee date, and termination ref. To specify a full termination, an investment advisor may enter the full termination amount. For a partial termination, the investment advisor may enter the partial termination amount.

The investment advisor may have the option to either enter the termination fee or the termination spread. If the investment advisor enters the termination spread instead of the termination fee, then the dealer may be required to enter the termination fee. Once the dealer has entered the termination fee, the investment advisor can either affirm or reject the termination fee.

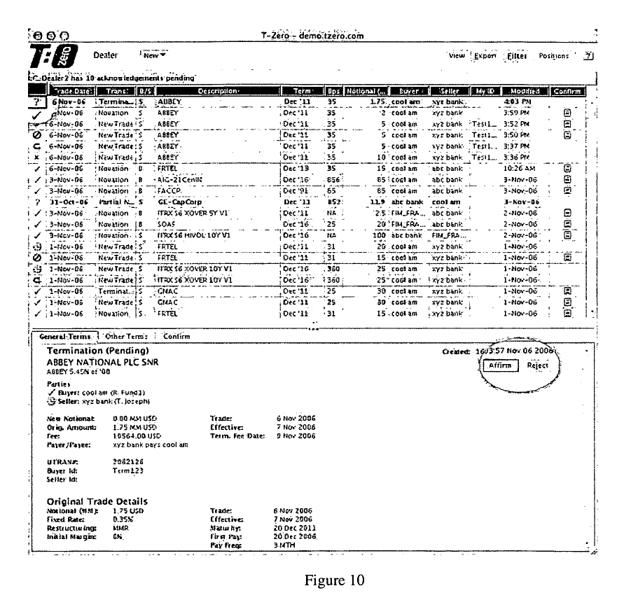

If all relevant fields are provided, the platform can send the termination to the dealer for affirmation. FIG. 10 shows an example of the main dealer screen after a termination has been received from an investment advisor. As shown in FIG. 10, the dealer is provided the opportunity to affirm or reject the termination with a single click.

The investment advisor may have the ability to recall a termination prior to affirmation of such termination. The platform may allow the investment advisor to modify and resubmit recalled terminations.

If the dealer affirms the termination, the platform can reduce the notional amount of the trade to the new notional. If the notional amount is reduced to 0 MM, the trade status can be set to terminated.

If the dealer rejects the termination, the platform can send a reject message back to the investment advisor. The dealer may be required to add a comment explaining why the termination was rejected. The platform may allow the investment advisor to modify and resubmit the rejected trade.

Either party may have the ability to void a termination that has been affirmed. Both parties may be required to agree to the termination and add a comment explaining why the termination was voided. The platform may allow the investment advisor to modify and resubmit the voided Termination.

Novations

It is possible for two parties who have entered into a transaction to arrange for this transaction to be “novated” to a third party. For instance, an investment advisor may have entered into a transaction with a dealer on behalf of a number of funds. The investment advisor may wish to “transfer” its position under the trade to a new dealer. In order to achieve this, the contract between the investment advisor and the original dealer is terminated and replaced with an identical contract between the original dealer and the new dealer. This is referred as a “novation.” The novation may be agreed to by the investment advisor and the new dealer outside of the platform. The novation may then be affirmed using the platform.

In order to affirm the novation, the investment advisor enters the new transaction record into the platform, which is then affirmed by the new dealer and accepted by the original dealer. Although the original dealer (remaining party) may not always be aware of the novation prior to receiving a message through the platform, it may be required to consent to or deny the novation in line with ISDA Novation Protocol II. Once affirmed and accepted by all the parties, the original dealer and the new dealer become party to a new transaction under the terms set out in the transaction record, and the transaction between the investment manager and the original dealer is terminated.

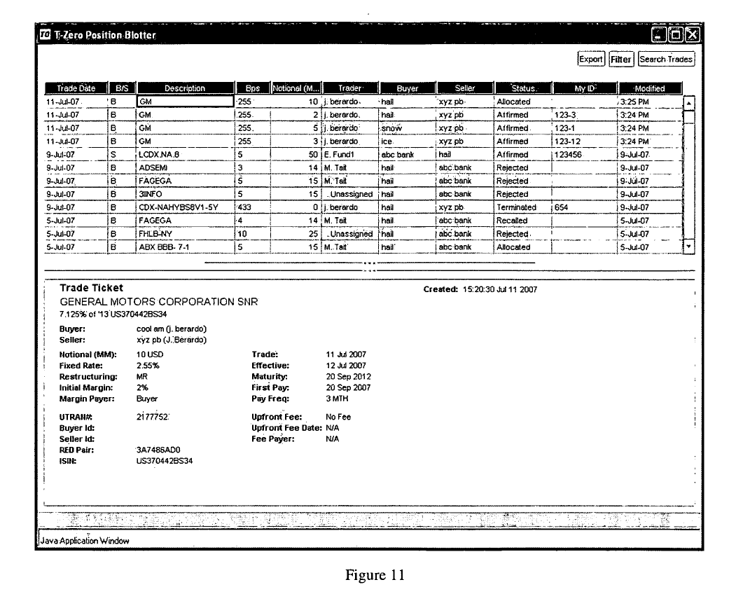

Following is a more detailed description of the novation procedure between an investment advisor and two dealers. A novation can be initiated by the investment advisor (the “transferor”), who alleges the novation details to both the original dealer (the “remaining party”) and the dealer stepping into the trade (the “transferee”). FIG. 11 is an example of an investment advisor's position blotter screen. This screen shows an investment adviser's outstanding positions. An investment advisor may initiate a novation or termination of a position affirmed via the platform from this screen.

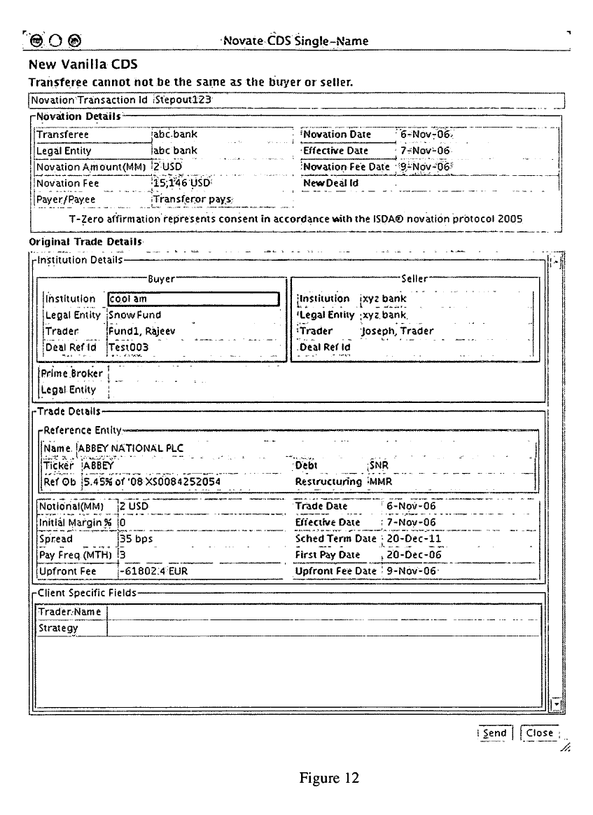

If the original trade was affirmed via the platform, the investment advisor may select an option to novate the trade and enter the relevant novation details (as discussed below). The investment advisor may have the option to novate: (a) a single allocation, (b) an entire block trade or (c) multiple allocations within a block trade. If the original trade was not affirmed via the platform, the investment advisor may enter the original trade details, as well as the novation details, into the platform. FIG. 12 is an example of an investment advisor's screen for entering details for novating a single name CDS contract transaction.

The novation details may include: transferee, novation amount, novation spread, novation fee, payer/payee, novation date, effective date, novation fee date, and novation ref.

To specify a full novation, the investment advisor may enter the full novation amount of the trade in the novation amount field. For a partial novation, the investment advisor may enter the partial novation amount.

The investment advisor may have the option to either enter the novation fee or the novation spread. If the investment advisor enters the novation spread instead of the novation fee, then the transferee may be required to enter the novation fee. Once the transferee has entered the novation fee, the investment advisor can either affirm or reject the novation fee.

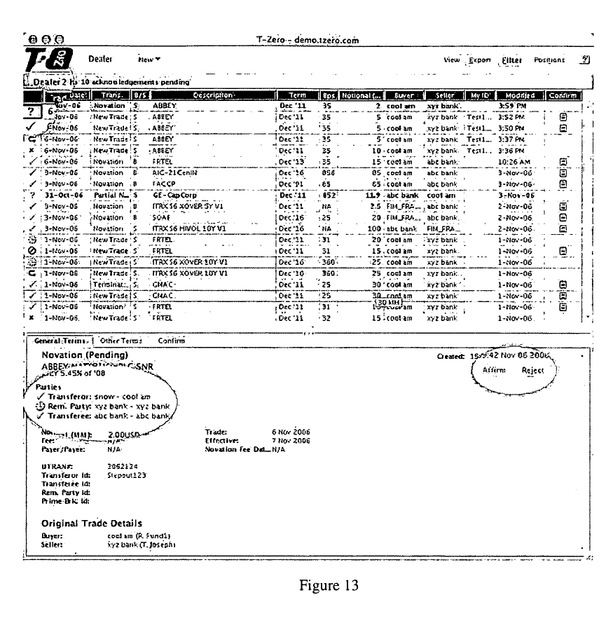

If all relevant fields are provided, the platform may send the novation simultaneously to both the transferee and the remaining party for affirmation. Both dealers may either affirm or reject the novation. FIG. 13 shows an example of a dealer screen after receipt of an alleged novation. The dealer has the choice of affirming or rejecting the novation using one click.

The investment advisor may the ability to recall a novation prior to affirmation of such novation. The platform may allow the investment advisor to modify and resubmit recalled novations.

If the novation is affirmed by both dealers: (a) The platform may reduce the notional amount of the trade between the transferor and remaining party by the novation amount. If the notional amount is reduced to 0 MM, the trade status can be set to novated. (b) The platform may create a new trade between the remaining party and the transferee of the novation amount with all of the same trade details as the original trade.

If either dealer rejects the novation, the platform may send a reject message back to the other dealer and the investment advisor. The rejecting dealer may be required to add a comment explaining why the novation was rejected. The platform may allow the investment advisor to modify and resubmit rejected trades.

If the novation is affirmed, either party has the ability to void the novation. All three parties may be required to agree on the void and add a comment explaining why the novation was voided. The platform may allow the investment advisor to modify and resubmit a voided novation.

Prime Broker “Give-Up”

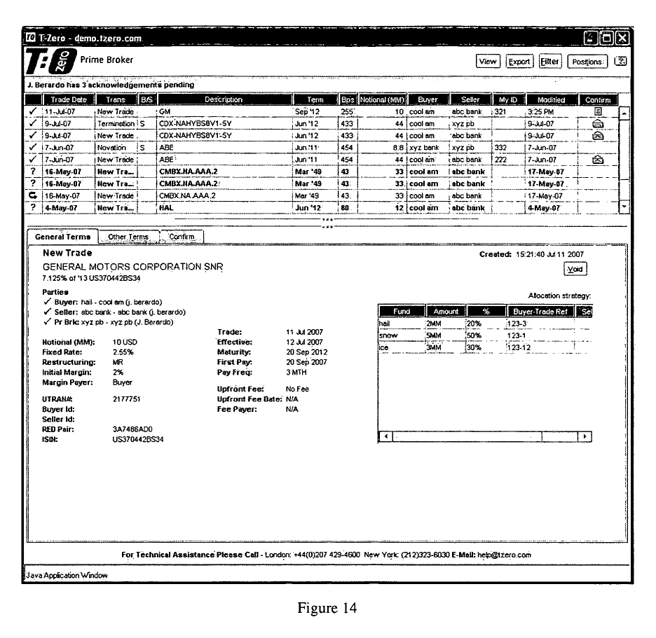

A prime broker “give-up” occurs when an investment advisor enters into a transaction with a dealer and informs the dealer that it is “giving-up” its transaction to a designated prime broker (usually a dealer in order to obtain margin or collateral relief). The dealer then enters details of the transaction into the platform and indicates that his trade counterparty is the prime broker. The investment advisor and its prime broker each may need to affirm (or reject) the details of the trade on the platform. FIG. 14 is an example of a prime broker give-up acceptance screen.

If accepted via the platform, this transaction results in the original trade between the dealer and the investment advisor being given-up to the prime broker and replaced by (i) a transaction between the dealer and the prime broker and (ii) transaction(s) between the prime broker and the investment advisor acting on behalf of one or more funds. The platform may also handle communication of termination and novation transaction information to prime brokers. Prime brokers may be classified into two types, step out and stay-in. A stay-in prime broker can act as the remaining party to a novation transaction initiated by their clients whereas a step-out prime broker will exit the trade with the executing broker when their client novates. The platform may handle the messaging of the transaction details specific to the type of prime broker in the transaction.

Following are examples of workflows involving a prime broker:

New Trade Workflow (Dealer Versus Investment Advisor Via Prime Broker Give Up)

The new trade affirmation process may be initiated by the dealer and affirmed by the investment advisor and prime broker. The dealer may enter all relevant trade details of the trade, including the prime broker to whom the trade is being given-up. The investment advisor can either affirm or reject the trade. If the investment advisor desires to allocate the trade across multiple Funds, it may do so prior to affirmation of the trade details.

The dealer may have the ability to recall a trade prior to affirmation of such trade. The platform may allow the dealer to modify and resubmit recalled trades.

If the trade is affirmed by the investment advisor, the prime broker may be notified of the trade give up and a clock may start running for that Trade. The clock indicates the response time within which the prime broker has to action the trade give up. The prime broker can either affirm or reject the trade.

If the trade is affirmed by both the investment advisor and prime broker: (a) For the investment advisor: the platform may generate a single trade ticket for the trade if the trade was not allocated, or a separate trade ticket for each allocation where the trade was allocated across multiple funds. (b) For the Prime Broker: the platform may generate a single trade ticket for the trade against the investment advisor if the trade was not allocated, or a separate trade ticket for each allocation where the trade was allocated across multiple funds. The platform may also generate a single trade ticket for the trade against the dealer. The notional amount on this trade ticket may be the sum of the allocated trades if the investment advisor allocated across multiple funds. (c) For the dealer: the platform may generate a single trade ticket for the trade against the prime broker. The notional amount on this trade ticket may be the sum of the allocated trades if the investment advisor allocated across multiple funds.

If the trade is rejected by either the investment advisor or the prime broker, the platform may send a reject message back to the parties on the trade. The party rejecting the trade may be required to add a comment explaining why the trade was rejected. The platform may allow the dealer to modify and resubmit rejected trades.

If the trade is affirmed, all parties may have the ability to void the Trade. All parties may be required to agree to the voided trade and to add a comment explaining why the trade was voided. The platform may allow the dealer to modify and resubmit voided trades.

Termination Workflow (Dealer Versus Investment Advisor for Prime Broker Give-Up Trade)

Terminations can be initiated by the investment advisor, who alleges the termination details to the dealer and prime broker. If the original trade was affirmed via the platform, the investment advisor may select the option to terminate the trade and enter the relevant termination details (as defined below). The investment advisor may have the option to terminate (a) a single allocation, (b) an entire block trade or (c) multiple allocations within a block trade. If the original trade was not affirmed via the platform, the investment advisor may enter the original trade details, as well as the termination details, into the platform.

The termination details may include: termination amount, termination spread, termination fee, payer/payee, termination date, effective date, termination fee date, and termination ref.

To specify a full termination, the investment advisor may enter the full termination amount. For a partial termination, the investment advisor may enter the partial termination amount.

The investment advisor may have the option to either enter the termination fee or the termination spread. If the investment advisor enters the termination spread instead of the termination fee, then the dealer may be required to enter the termination fee. Once the dealer has entered the termination fee, the investment advisor may either affirm or reject the termination fee.

If all relevant fields are provided, the platform may send the termination to both the dealer and the prime broker for affirmation. Both parties can either affirm or reject the termination.

The investment advisor may have the ability to recall a termination prior to affirmation of such termination. The platform may allow the investment advisor to modify and resubmit recalled terminations.

If the termination is affirmed by the dealer and the prime broker, the platform may reduce the notional amount of the trade to the new notional. If the notional amount is reduced to 0 MM, the trade status may be set to terminated.

If either the dealer or prime broker rejects the termination, the platform may send a reject message back to the other parties. The party rejecting the trade may be required to add a comment explaining why the trade was rejected. The platform may allow the investment advisor to modify and resubmit rejected trades.

If the termination is affirmed, all parties may have the ability to void the termination. All parties may be required agree to void the termination and to add a comment explaining why the termination was voided. The platform may allow the investment advisor to modify and resubmit voided terminations.

Novation Workflow (Dealer Versus Investment Advisor for Prime Broker Give-Up Trade)

Following are two workflows for novation of a trade given up to a prime broker: (a) The prime broker acts as the remaining party in the novation; or (b) The prime broker steps out of the trade by simultaneously terminating the trade with the investment advisor and novating the trade with the dealer on the other side.

The platform may automatically select one of the two workflows based on a preference specified by the prime broker. In both cases, the novation may be initiated by the investment advisor and affirmed by the dealer(s) and prime broker. If the original trade was affirmed via the platform, the investment advisor may select the option to novate the trade and enter the relevant novation details (as defined below). The investment advisor has the option to novate (a) a single allocation, (b) an entire block trade or (c) multiple allocations within a block trade. If the original trade was not affirmed via the platform, the investment advisor may enter the original trade details, as well as the novation details, into the platform.

The novation details may include: transferee, novation amount, novation spread, novation fee, payer/payee, novation date, effective date, novation fee date, novation ref.,

To specify a full novation, the investment advisor may enter the full novation amount of the trade in the novation amount field. For a partial novation, the partial notional amount being novated may be entered under the “novation amount” field.

The investment advisor may have the option to either enter the novation fee or the novation spread. If the investment advisor enters the novation spread instead of the novation fee, then the transferee may be required to enter the novation fee. Once the transferee has entered the novation fee, the investment advisor may either affirm or reject the novation fee.

Novation Workflow (Prime Broker is the Remaining Party)

For the workflow where the prime broker acts as the remaining party, the platform may send the novation to the transferee (dealer) and remaining party (prime broker) for affirmation. Both parties may either affirm or reject the novation.

The investment advisor may have the ability to recall a novation prior to affirmation of such novation. The platform may allow the investment advisor to modify and resubmit recalled novations.

If the novation is affirmed by both parties: (a) The platform may reduce the notional amount of the trade between the transferor (investment advisor) and remaining party (prime broker) by the novation amount. If the notional amount is reduced to 0 MM, the trade status may be set to novated. (b) The platform may create a new trade between the remaining party (prime broker) and the transferee (dealer) of the novation amount with all of the same trade details as the original trade.

If either party rejects the novation, the platform may send a reject message back to the parties. The party rejecting the trade is required to add a comment explaining why the trade was rejected. The platform may allow the investment advisor to modify and resubmit rejected trades.

If the novation is affirmed, all parties have the ability to void the novation. All parties are required to add a comment explaining why the novation was voided. The platform may allow the investment advisor to modify and resubmit voided novations.

Novation Workflow (Prime Broker Steps Out)

For the workflow where the prime broker steps out of the trade, the platform may send the novation to the transferee (dealer), transferor (prime broker) and remaining party (dealer) for affirmation. All parties may either affirm or reject the novation.

The investment advisor may have the ability to recall a novation prior to affirmation of such novation. The platform may allow the investment advisor to modify and resubmit recalled novations.

If the novation is affirmed by all parties: (a) The platform may reduce the notional amount of the trade between the prime broker and the investment advisor by the novation amount. If the notional amount is reduced to 0 MM, the trade status may be set to terminated. (b) The platform may reduce the notional amount of the trade between the transferor (prime broker) and remaining party (dealer) by the novation amount. If the notional amount is reduced to 0 MM, the trade status may be set to novated. (c) The platform may create a new trade between the remaining party (dealer) and the transferee (dealer) of the novation amount with all of the same trade details as the original trade.

If any party rejects the novation, the platform may send a reject message back to the parties. The party rejecting the trade may be required to add a comment explaining why the trade was rejected. The platform may allow the investment advisor to modify and resubmit rejected trades.

If the novation is affirmed, all parties may have the ability to void the novation. All parties may be required to agree to void the novation and add a comment explaining why the novation was voided. The platform may allow the investment advisor to modify and resubmit voided novations.

Platform_Auto-Affirmation

Platform auto-affirmation provides buy-side clients (for example, an investment advisor) one or more of the following features: a)The ability to electronically capture new trade details with allocations from trade capture systems without waiting for dealers to message trade details. b) Automatic comparison and affirmation of investment advisor captured new trade details against dealer messaged new trade details. c) Electronic messaging of investment advisor trade allocations to dealer counterparties upon automatic affirmation. d) Exception processing tools to resolve un-affirmed captured transactions.

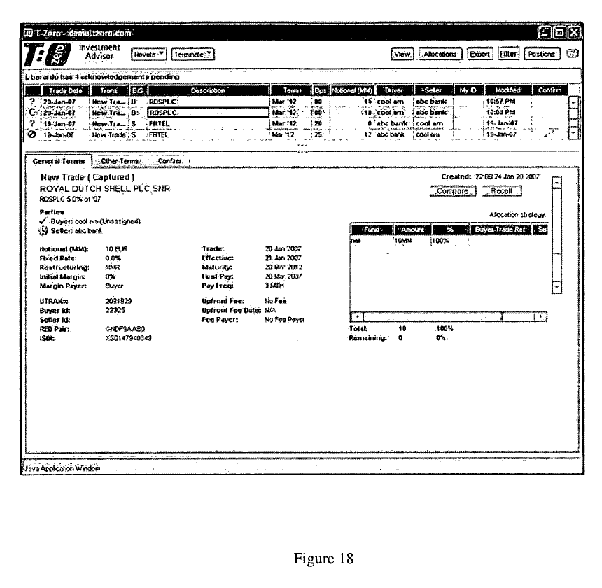

To capture new trades on the platform using auto-affirmation, the following procedure is performed: 1) New trade and allocation details from the investment advisors trade capture system is delivered to platform (for example, via the platform API). These details are captured and used in the auto-affirmation process (In ‘captured’ status). 2) Upon capturing the trade, the platform applies a unique UTRAN# trade identifier to the captured trade and delivers an acknowledgement that the transaction was successfully captured. 3) The platform displays the captured transaction in the transaction blotter for the investment advisor (which may be recalled by the investment advisor if not already automatically affirmed). FIG. 18 shows an example of the capture new trade on an investment advisor screen.

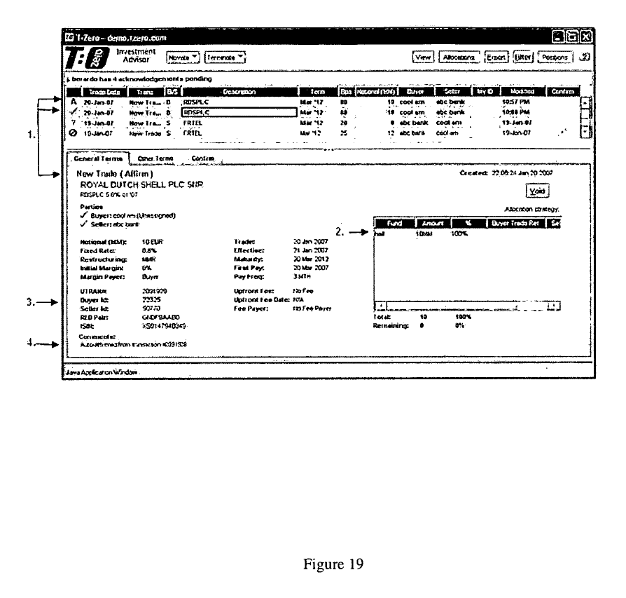

Captured trades may be automatically affirmed by the platform. Upon receipt of the captured buy-side new trade, the platform may automatically compare the block trade details against all dealer alleged transactions and automatically affirm transactions where all key comparable fields are in agreement (based on, for example, product, buyer/seller legal entity names, reference entity/obligation, dates, and payment information; an automatic 50 EUR/USD tolerance is applied when comparing upfront fees. FIG. 19 shows an example of an investment advisor screen of an auto-affirmed new trade.

As shown in FIG. 19, if a new comparable trade is found, the platform may automatically: 1) Affirms the dealer alleged trade; changes the captured investment advisor trade transaction status from “captured” to “auto-affirm.” 2) Applies and delivers allocations to the dealer affirmed trade (with notional breakdowns and buy-side trade IDs). 3) Enriches the auto-affirmed dealer block trade with captured internal trade identifiers/client defined fields. 4) References the platform UTRAN# of the captured transaction that was automatically affirmed using dealer provided trade details.

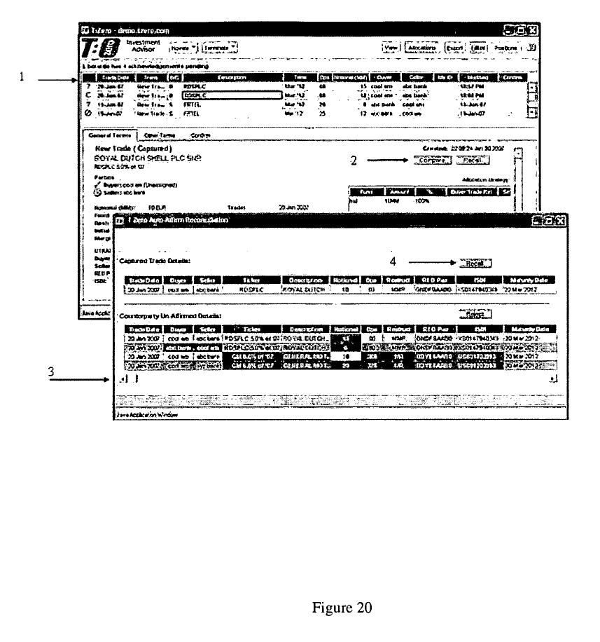

To reconcile un-affirmed transactions, the investment advisors can either reconcile trades normally or can use the following tools and procedures described with respect to FIG. 20. FIG. 20 shows investment advisor screens used for reconciling a trade that was not auto affirmed. To reconcile trades using the interface in FIG. 20 the investment advisor: 1) Selects the captured trade in the transaction blotter to view the captured trade details. 2) Selects the ‘compare’ button of in the details section to open a position reconciliation screen. The screen can list all un-affirmed dealer alleged new trades for the product type and trade date by order of most to least number of fields that are in agreement. 3) Review the buy-side captured trade details that don't agree with the dealer alleged trade details (highlighted in red) and either reject a dealers allege (with a reject reason) or repair the trade details in the buy-side trade Capture system and re-capture the new trade details. 4) Should the buy-side trade capture system not support trade cancels, users may purge erroneous un-affirmed captured transactions by selecting the Recall button on the Platform GUI.

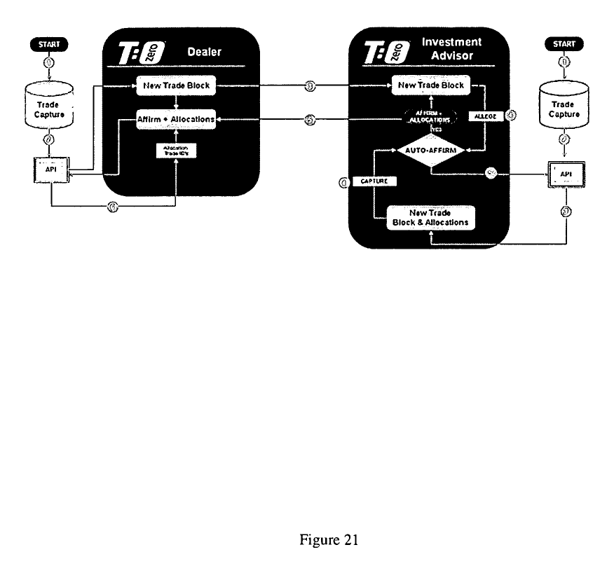

FIG. 21 is a flowchart summarizing the auto-affirmation features. Following is a description of the flow diagram: 1) Initiate trade: dealer and investment advisor execute a new block trade and enter trade details in their respective trade capture systems. 2) Submit trade: dealer and investment advisor submit the trade details to the platform. 3) Allege/capture transaction: the platform delivers the dealer submitted trade details (allege) to the investment advisor; the platform creates a transaction (‘capture’ new trade status) for investment advisor captured new trades used for automatic affirmation purposes. 4) Comparison of trade details/automatic affirmation: The platform auto-affirmation engine compares the investment advisor captured auto-affirm trade details against all dealer alleged new trade transactions and automatically affirms the dealer alleged transaction when all fields are in agreement; the captured investment advisor new trade status is set to ‘auto-affirm’. 5) Allocations applied/trade identifiers copied: the platform, upon automatic affirmation, automatically copies the investment advisor allocations, trade ID's, and client defined fields from the captured auto-affirm transaction to the dealer alleged transaction and delivers the allocation to the dealer (captured investment advisor new trade status is delivered via API). 6) Deal enrichment: dealers, upon receiving the affirmed trade and allocations, submits its internal trade ID's for each allocation leg.

In the auto-affirmation system captured new trades may be 100% allocated to either a block entity (i.e. no allocation) or to established funds on the platform. The platform may not allow captured new trades to be modified. The platform may allow trades to be recalled; corrected trade details in the investment advisor's trade capture system can be messaged to platform as a separate captured new trade.

Captured new trades may only be visible to the buy-side firm; upon auto-affirmation, dealers may only see the captured trade allocations that were copied to the dealer messaged new trade (as if the trade was manually affirmed and allocated).

A transporter tool can be part of the platform the transporter tool may allow users to upload trade capture details in a spreadsheet format (for example csv format) for use with auto-affirmation. The uploaded details may be viewed in a transporter viewer. Using the transporter upload tool, users may save the trade capture spreadsheet details to a server directory where the transporter delivers the trade details to the platform. Users may be able to see a list of captured, auto-affirmed, and trade upload errors in a browser based transporter file viewer by selecting the appropriate folder.

Credit Option_Expiry System

The platform may also include a system for exercising credit derivative options.

CDS options tend to expire on 20 March, 20 June, 20 September, 20 December of a given year. As a result there is a large concentration of work that needs to be performed on these days in relation to the decision to exercise and option (or otherwise).

On maturity date of the option, the buyer of the option typically has to decide between 9 am and 4 pm whether to exercise any options they have bought. To do this, the exercise price on all options that a trader has bought needs to be compared to the current price for the underlying CDS contract in the market. Currently most of this work has to be done manually and each option has to be exercised individually. The platform may provide a more efficient process for exercising CDS options.

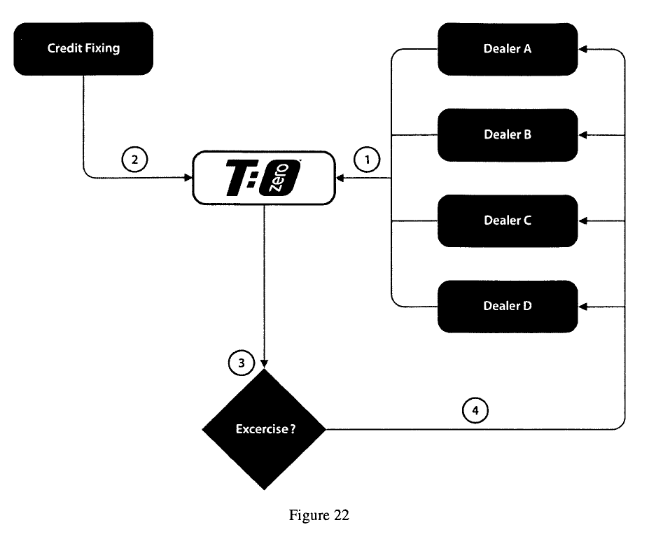

FIG. 22 is a flow diagram of the process for exercising CDS options on the platform. In FIG. 4, Step 1—is the load and affirming of the trades. This can be done in a similar manner to the method for loading other trades onto the platform. Where possible, the platform may accept straight-through-processing solutions in the same way that it may for typical credit derivatives. A bulk upload tool can be used to allow for multiple trades to be quickly and easily uploaded from Microsoft EXCEL or other file formats. Once all trades are loaded they may be affirmed in the usual manner before they can be exercised. In step 2, a credit feed is received from www.Creditfixings.com, or from a similar source. This feed provides the appropriate weekly credit fixing for all credits currently covered by the fixings process. This provides an accurate representation of the market at 11 am and can be used to decide which options to exercise. In step 3 the buyer decides which options to exercise and in step 4 the options to be exercised are communicated to counterparties.

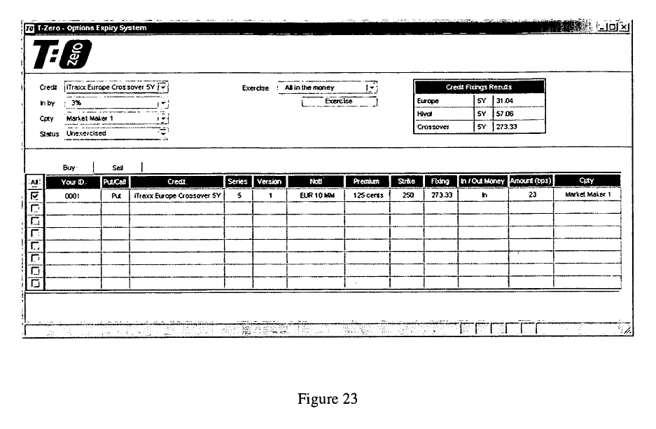

FIG. 23 is a view of the option screen for an option buyer. Each trade is listed either on the buy or sell tab, and may only be listed once it has been affirmed by both counterparties.

Buyers can select an individual trade to execute by selecting the tickbox against that trade on the left hand side and then pressing the exercise button. Buyers may have the option to filter the list of visible trades by, for example, credit, counterparty, status, and % difference between the underlying market and Strike on the Options.

Buyers may also be able to elect to bulk exercise all selected trades, all trades “in the money” (i.e. that have value to the owner by exercising the option), and all trades “in the money” by a certain percentage. On the sell tab dealers may automatically see those options that they have sold, where the buyer is exercising the option.

Once a trade has been exercised, a message may be sent to the appropriate counterparty on platform. The platform may also automatically generates the standard ISDA confirmation for this trade. Exercise of an option results in the creation of a new trade, and this can be automatically created and booked on the platform if requested by the user.

Credit Event Services

The platform may also support delivery of Credit Event Notices (CENs). CENs are contractual correspondence used between credit derivative buyers and sellers when the defined underlying legal entity in a traded default swap experiences a credit event (such as a bankruptcy or defaults on a payment).

After the CEN's are delivered (usually with an attached public notice detailing the event) and acknowledged, protection buyers communicate their settlement preferences to protection sellers in a letter called the Notice of Physical Settlement (NOPS). Settlement preferences include: referenced bonds/obligations, settlement pricing, and indication of cash or physical settlement).

Processing and settlement of credit events typically must be done between specific timelines and terms or protection buyers could lose their settlement preferences or the ability to settle at all; an inherent risk. This risk is further aggravated by the current process which is decentralized and largely manual (fax, email, mail).

The platform can include functionality to permit the electronic delivery and affirmation of CEN's and NOPS in order to reduce the risks associated with processing credit events and help centralize the process.

More specifically, the platform may allow users to upload event affected trades using, for example, Excel, Flat File, or FpML, of which, can be validated against DTCC. The platform can also include a counterparty contact database with, for example, an Institution name, address, and event central point of contact (name phone, fax, bloomberg, and email addresses). This database can be accessible, for example, via the GUI and third parties website (ISDA website).

The platform may allow dealers to electronically deliver CENs (with attached Publicly Available Information; in PDF or DOC format) for any platform entered position to Investment Advisors (not a legal affirmation but independent delivery guarantor). Email and Bloomberg delivery can be available options (with CNOS like indicators of such). Dealers may also have the ability to recall CEN's delivered in error.

The platform may calculate and display remaining time to deliver NOPS to parties.

Buyers of protection may be able to deliver settlement notices electronically over the platform (the platform may allow updating of the reference obligation, cash or physical settlement, auction eligibility, ISDA credit definitions, and use of ISDA Index settlement protocol).

The platform may provide API support, for supporting, for example, Bloomberg CEN message delivery.

Protection buyers may have the option to net positions across counterparties to reduce multiple settlements due to off-setting positions. The platform may also allow net positions to be used in market order calculations for auction process.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Other embodiments and uses of the invention will be apparent to those skilled in the art from consideration of the specification and practice of the invention disclosed herein. All references cited herein, including all U.S. and foreign patents, patent applications, all publications and other documentary materials, are specifically and entirely hereby incorporated by reference.

What is claimed is:

1. A method comprising:
receiving from a first party trade details concerning a credit derivative trade;
transmitting the trade details to a second party;
receiving from the second party an affirmation or a rejection; and
notifying the first party of the affirmation or the rejection.

2. The method of claim 1, wherein a rejection is received from the second party.

3. The method of claim 2, further comprising receiving a reason for the rejection from the second party.

4. The method of claim 2, further comprising receiving modified trade details from the first party following the rejection.

5. The method of claim 4, further comprising transmitting the modified trade details to the second party and receiving from the second party an affirmation of the modified trade details.

6. The method of claim 1, further comprising transmitting the trade details to a matching trade settlement system.

7. A method of novating a credit derivative trade comprising:
receiving from a transferor details concerning an original credit derivative transaction between the transferor and a remaining party;
transmitting the trade details to the remaining party and a transferee;
receiving from the remaining party an affirmation or a rejection;
receiving from the transferee an affirmation or a rejection; and
notifying the transferor of the affirmation or rejection received from the remaining party and the transferee.

8. The method of claim 7, further comprising affirming the novation if an affirmation is received from both the remaining party and the transferee.

9. The method of claim 7, further comprising rejecting the novation if a rejection is received from either the remaining party or the transferee.

10. The method of claim 7, comprising receiving a rejection from the remaining party or the transferee.

11. The method of claim 10, further comprising receiving a reason for the rejection along with the rejection.

12. The method of claim 7, further comprising receiving modified trade details from the transferor following a rejection.

13. The method of claim 12, further comprising transmitting the modified trade details to the remaining party and the transferee.

14. The method of claim 13, further comprising receiving an affirmation of the modified trade details from the remaining party and the transferee.

15. The method of claim 14, further comprising transmitting the modified trade details to a matching trade settlement system.

16. The method of claim 7, further comprising transmitting the trade details to a matching trade settlement system.

17. A method of auto-affirming trade details comprising:
receiving from a first party first trade details concerning a credit derivative trade;
receiving from a second party second trade details concerning a credit derivative trade;
transmitting the first trade details to the second party; and
auto-affirming the first trade details when the first trade details match the second trade details.

18. A method for exercising credit derivative options comprising:
receiving details concerning a plurality of credit derivative options;
receiving weekly fixings concerning the plurality of credit derivative options;
displaying the weekly fixings to a first party; and
receiving from the first party an indication of whether to exercise one or more of the plurality of credit derivative options.

19. The method of claim 18, further comprising transmitting to a second party the indication of whether to exercise one or more of the plurality of credit derivative options.

20. A trade system comprising:
a first party system comprising a first party interface configured to receive from a first party trade details concerning a credit derivative trade; and
a second party system in communication with the first party system and comprising a second party interface configured to receive from a second party an affirmation or a rejection concerning the trade details.

21. A trade system comprising:
a first party system comprising a first party interface configured to receive from a first party trade details concerning a credit derivative trade;
a second party system in communication with the first party system and comprising a second party interface configured to receive from a second party an affirmation or a rejection concerning the trade details; and
a third party system in communication with the first party system and comprising a third party interface configured to receive from a third party an affirmation or a rejection concerning the trade details.
